(19) United States
(12) Patent Application Publication
(10) Pub. No.: US 2026/0239248 A1
(43) Pub. Date: Aug. 13, 2026

(54) APPARATUSES, METHODS, AND MEDIUM FOR DUAL CONNECTIVITY COMMUNICATION

(71) Applicant: Nokia Technologies Oy, Espoo (FI)

(72) Inventors: Samuli Heikki TURTINEN, Oulu (FI); Jarkko Tuomo KOSKELA, Oulu (FI); Chunli WU, Beijing (CN); Tero HENTTONEN, Espoo (FI)

(21) Appl. No.: 19/157,054

(22) PCT Filed: Feb. 28, 2023
(86) PCT No.: PCT/CN2023/078882

§ 371 Date: Aug. 15, 2025

(51) Int. Cl. H04W 56/00; H04L 1/1812; H04L 1/1829

(52) U.S. Cl. CPC H04W 56/0045; H04L 1/1812; H04L 1/1835

(57) ABSTRACT

Embodiments of the present disclosure disclose devices, methods and apparatuses for dual connectivity (DC) communication. In the embodiments, a terminal device determines an activation or deactivation of a SCG of the terminal device. Then, the terminal device flushes, based at least on the determining the activation or the deactivation of the SCG, one or more HARQ buffers associated with a PSCell of the terminal device. In this way, the performance of the DC communication system can be improved.

### FIELD

Embodiments of the present disclosure generally relate to the field of telecommunication, and in particular, to apparatuses, methods, and a computer readable storage medium for dual connectivity (DC) communication.

### BACKGROUND

With the development of technology, radio resources within multiple carriers can be utilized for improving UE throughput, such as employing carrier aggregation (CA) and/or dual connectivity technology. Taking the DC communication as an example, UE is allowed to simultaneously transmit and receive data on multiple component carriers from two cell groups, such as a master cell group (MCG) and a secondary cell group (SCG), via master eNodeB (MN) and secondary eNodeB (SN). Furthermore, a hybrid automatic repeat request (HARQ) technology is a mechanism for increasing the success rate in data transmission. One or more HARQ buffers are configured to one or more HARQ processes for data packet combining.

In Release 17 (TS 38.300), deactivation of an SCG is supported. In this case, the management of the HARQ buffers can be optimized.

### SUMMARY

In general, example embodiments of the present disclosure provide devices, methods, apparatuses and a computer readable storage medium for the DC communication.

In a first aspect, there is provided an apparatus. The apparatus may comprise at least one processor and at least one memory storing instructions that, when executed by the at least one processor, cause the apparatus at least to determine an activation or deactivation of a SCG of the apparatus. The apparatus is further caused to flush, based at least on the determining the activation or deactivation of the SCG, one or more HARQ buffers associated with a primary secondary cell (PSCell) of the apparatus.

In a second aspect, there is provided an apparatus. The apparatus may comprise at least one processor and at least one memory storing instructions that, when executed by the at least one processor, cause the apparatus at least to receive, from a terminal device, information related to capability of at least one of: flushing one or more HARQ buffers associated with a PSCell of the terminal device while a timeAlignmentTimer associated with a primary timing advance group (PTAG) for the terminal device is running; or flushing one or more HARQ buffers associated with a PSCell upon an activation or deactivation of a SCG.

In a third aspect, there is provided a method. In the method, a terminal device determines an activation or deactivation of a SCG of the terminal device. Then, the terminal device flushes, based at least on the determining the activation or deactivation of the SCG, one or more HARQ buffers associated with a PSCell of the terminal device.

In a fourth aspect, there is provided a method. In the method, a network device receives, from a terminal device, information related to capability of at least one of: flushing one or more HARQ buffers associated with a PSCell of the terminal device while a timeAlignmentTimer associated with a PTAG for the terminal device is running; or flushing one or more HARQ buffers associated with a PSCell upon an activation or deactivation of a SCG.

In a fifth aspect, there is provided an apparatus. The apparatus comprises: means for determining an activation or deactivation of a SCG of the apparatus; and means for flushing, based at least on the determining the activation or deactivation of the SCG, one or more HARQ buffers associated with a PSCell of the apparatus.

In a sixth aspect, there is provided an apparatus. The apparatus comprises: means for receiving, from a terminal device, information related to capability of at least one of: flushing one or more HARQ buffers associated with a PSCell of the terminal device while a timeAlignmentTimer associated with a PTAG for the terminal device is running; or flushing one or more HARQ buffers associated with a PSCell upon an activation or deactivation of a SCG.

In a seventh aspect, there is provided a non-transitory computer readable medium comprising program instructions that, when executed by an apparatus, cause the apparatus to perform at least: determining an activation or deactivation of a SCG of the apparatus; and flushing, based at least on the determining the activation or deactivation of the SCG, one or more HARQ buffers associated with a PSCell of the apparatus.

In an eighth aspect, there is provided a non-transitory computer readable medium program instructions that, when executed by an apparatus, cause the apparatus to perform at least: receiving, from a terminal device, information related to capability of at least one of: flushing one or more HARQ buffers associated with a PSCell of the terminal device while a timeAlignmentTimer associated with a PTAG for the terminal device is running; or flushing one or more HARQ buffers associated with a PSCell upon an activation or deactivation of a SCG.

In a ninth aspect, there is provided a computer program comprising instructions, which, when executed by an apparatus, cause the apparatus at least to determine an activation or deactivation of a SCG of the apparatus. The apparatus is further caused to flush, based at least on the determining the activation or deactivation of the SCG, one or more HARQ buffers associated with a PSCell of the apparatus.

In a tenth aspect, there is provided a computer program comprising instructions, which, when executed by an apparatus, cause the apparatus at least to receive, from a terminal device, information related to capability of at least one of: flushing one or more HARQ buffers associated with a PSCell of the terminal device while a timeAlignmentTimer associated with a PTAG for the terminal device is running; or flushing one or more HARQ buffers associated with a PSCell upon an activation or deactivation of a SCG.

In an eleventh aspect, there is provided a terminal device. The terminal device comprises a determining circuitry configured to determine an activation or deactivation of a SCG of the terminal device; and a flushing circuitry configured to flush, based at least on the determining the activation or deactivation of the SCG, one or more HARQ buffers associated with a PSCell of the terminal device.

In a twelves aspect, there is provided a network device. The network device comprises a receiving circuitry configured to receive, from a terminal device, information related to capability of at least one of: flushing one or more HARQ buffers associated with a PSCell of the terminal device while a timeAlignmentTimer associated with a PTAG for the terminal device is running; or flushing one or more HARQ buffers associated with a PSCell upon an activation or deactivation of a SCG.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example network environment in which embodiments of the present disclosure may be implemented;

FIG. 2 illustrates an example signaling process for the DC communication according to some embodiments of the present disclosure;

FIG. 3 illustrates flowchart of a method implemented at a terminal device according to example embodiments of the present disclosure;

FIG. 4 illustrates an example flowchart of a method implemented at a network device according to example embodiments of the present disclosure;

FIG. 5 illustrates an example simplified block diagram of an apparatus that is suitable for implementing embodiments of the present disclosure; and

FIG. 6 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit (s) with software/firmware and
(ii) any portions of hardware processor (s) with software (including digital signal processor (s)), software, and memory (ies) that work together to cause an apparatus, such as a mobile phone or server, to perform various functions) and
(c) hardware circuit (s) and or processor (s), such as a microprocessor (s) or a portion of a microprocessor (s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, 5G-A, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio, (NR) NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the SCG may refer to a group of secondary cells provided for the terminal device by a secondary eNodeB (SN) of a terminal device. In the DC communication, the terminal device may access the network via both a master cell group (MCG) provided by a master eNodeB (MN) of the terminal device and the SCG. Furthermore, the MCG may include a primary cell (PCell) and one or more secondary cells (SCell). The SCG may include a primary secondary cell (PSCell) and one or more other SCells. In general, the deactivation of the SCells is supported. However, the SCG including the PSCell cannot be deactivated completely, since the PSCell deactivation is not supported.

As mentioned above, in Release 17, the SCG deactivation feature is specified. Specifically, the SCG deactivation is defined as below:

7.13 Activation and Deactivation of SCG
To enable reasonable UE battery consumption while having fast usage of SCG when
(NG)EN-DC or NR-DC is configured, an activation/deactivation mechanism of SCG is
supported. While the SCG is deactivated, there is no transmission via SCG RLC bearers.
Only the NR SCG can be deactivated, and all SCG SCell(s) are in deactivated state while
the SCG is deactivated.
Upon SCG deactivation and while the SCG is deactivated, the network ensures that there
is no uplink control PDU transmission to the deactivated SCG (e.g. the network releases
statusReportRequired from PDCP entities of SCG bearers if configured, the network
does not perform QoS flow remapping from a DRB associated to the deactivated SCG to
another DRB). The network ensures the SCG is activated while PDCP duplication is
activated for SCG RLC entities associated with a PDCP entity.
NOTE: Upon SCG (de)activation, it is up to the network to ensure there is no pending
SDUs or PDUs in SCG RLC entity (e.g. instructs the UE to perform PDCP data recovery
and RLC re-establishment/release, if needed).
While the SCG is deactivated, the UE will not transmit PUSCH, SRS and CSI report on
SCG, and the UE is not required to monitor PDCCH or receive DL-SCH on SCG. If
configured by the network, the UE performs radio link monitoring on the SCG and beam
failure detection on the SCG while SCG is deactivated. In case of SCG activation
without performing random access, the network can indicate TCI states to UE for
PDCCH/PDSCH reception on PSCell, if not provided, the UE uses the previously
activated TCI states.
The MN can configure the SCG as activated or deactivated upon e.g. PSCell addition,
PSCell change, RRC Resume or handover. In case the SCG is configured as deactivated,
the UE does not perform random access towards the PSCell. The network can trigger
SCG RRC reconfiguration (e.g. PSCell change, configuration update) when deactivating
the SCG and while the SCG is in deactivated state.
SCG activation can be requested by the MN, by the SN and by the UE. SCG deactivation
can be requested by the MN and by the SN. For UL data arrival on SCG bearer(s) while
the SCG is deactivated, the UE indicates to the MN that it has UL data to transmit over
SCG bearer. During handover procedure, the target MN can indicate the SCG state in the
RRC reconfiguration message sent to the UE by the source MN.
Network can configure whether the UE is allowed to indicate a preference for SCG
deactivation to the MN.

In this case, the SCG including PSCell can be deactivated completely. In one solution, only for the SCells deactivation, the associated HARQ buffers may be handled by flushing all HARQ buffers associated with the SCells. Specifically, the HARQ buffers can be handled in the following:

| | |
|---|---|
| 5.9 | Activation/Deactivation of SCells |

The MAC entity shall for each configured SCell:

| | |
|---|---|
| 1> | else if an SCell Activation/Deactivation MAC CE or an Enhanced SCell |

Activation/Deactivation MAC CE is received deactivating the SCell; or

| 1> | if the sCellDeactivationTimer associated with the activated SCell expires; or | |
|---|---|---|
| 1> | if the SCG associated with the activated SCell is deactivated: | |
| | 2> | deactivate the SCell according to the timing defined in TS 38.213 [6]; |
| | 2> | stop the sCellDeactivationTimer associated with the SCell; |
| | 2> | stop the bwp-InactivityTimer associated with the SCell; |
| | 2> | deactivate any active BWP associated with the SCell; |
| | 2> | clear any configured downlink assignment and any configured uplink grant |
| | Type 2 associated with the SCell respectively; | |
| | 2> | clear any PUSCH resource for semi-persistent CSI reporting associated with |
| | the SCell; | |
| | 2> | suspend any configured uplink grant Type 1 associated with the SCell; |
| | 2> | flush all HARQ buffers associated with the SCell; |
| | 2> | cancel, if any, triggered consistent LBT failure for the SCell. |

However, how to manage or handle the HARQ buffers associated with the PSCell has not been considered. In general, the HARQ buffers associated with the PSCell may be flushed only if a timeAlignmentTimer expires. This is defined as below:

| | |
|---|---|
| 5.2 | Maintenance of Uplink Time Alignment |

The MAC entity shall:

| 1> | when a timeAlignmentTimer expires: | |
|---|---|---|
| 2> | if the timeAlignmentTimer is associated with the PTAG: | |
| | 3> | flush all HARQ buffers for all Serving Cells; |
| | 3> | notify RRC to release PUCCH for all Serving Cells, if configured; |
| | 3> | notify RRC to release SRS for all Serving Cells, if configured; |
| | 3> | clear any configured downlink assignments and configured uplink grants; |
| | 3> | clear any PUSCH resource for semi-persistent CSI reporting; |
| | 3> | consider all running timeAlignmentTimers as expired; |
| | 3> | maintain NTA (defined in TS 38.211 [8]) of all TAGs. |

| | |
|---|---|
| 2> | else if the timeAlignmentTimer is associated with an STAG, then for all Serving |

Cells belonging to this TAG:

| | |
|---|---|
| 3> | flush all HARQ buffers; |
| 3> | notify RRC to release PUCCH, if configured; |
| 3> | notify RRC to release SRS, if configured; |
| 3> | clear any configured downlink assignments and configured uplink grants; |
| 3> | clear any PUSCH resource for semi-persistent CSI reporting; |
| 3> | maintain NTA (defined in TS 38.211 [8]) of this TAG. |

However, the running of the timeAlignmentTimer is not affected by the SCG deactivation or activation. This is defined as below:

| | |
|---|---|
| 5.12 | MAC Reset |

If a reset of the MAC entity is requested by upper layers or the reset of the MAC entity is
triggered due to SCG deactivation as defined in clause 5.29, the MAC entity shall:

| 1> | if the MAC reset is not due to SCG deactivation: | |
|---|---|---|
| | 2> | initialize Bj for each logical channel to zero; |
| 1> | initialize SBj for each logical channel to zero if Sidelink resource allocation mode 1 | |
| | is configured by RRC; | |
| 1> | if upper layers indicate SCG deactivation and bfd-and-RLM with value true is | |
| | configured for the deactivated SCG: | |
| | 2> | stop (if running) all timers except beamFailureDetectionTimer associated with |
| | | PSCell and timeAlignmentTimers. |
| 1> | else: | |
| | 2> | stop (if running) all timers, except MBS broadcast DRX timers; |
| | 2> | consider all timeAlignmentTimers, inactivePosSRS-TimeAlignmentTimer, and cg- |
| | | SDT-TimeAlignmentTimer, if configured, as expired and perform the |
| | | corresponding actions in clause 5.2; |
| 1> | set the NDIs for all uplink HARQ processes to the value 0; | |
| 1> | sets the NDIs for all HARQ process IDs to the value 0 for monitoring PDCCH in | |
| | Sidelink resource allocation mode 1; | |
| 1> | stop, if any, ongoing Random Access procedure; | |
| 1> | discard explicitly signalled contention-free Random Access Resources for 4-step RA | |
| | type and 2-step RA type, if any; | |
| 1> | flush Msg3 buffer; | |
| 1> | flush MSGA buffer; | |
| 1> | cancel, if any, triggered Scheduling Request procedure; | |
| 1> | cancel, if any, triggered Buffer Status Reporting procedure; | |
| 1> | cancel, if any, triggered Power Headroom Reporting procedure; | |
| 1> | cancel, if any, triggered consistent LBT failure; | |
| 1> | cancel, if any, triggered BFR; | |
| 1> | cancel, if any, triggered Sidelink Buffer Status Reporting procedure; | |
| 1> | cancel, if any, triggered Pre-emptive Buffer Status Reporting procedure; | |
| 1> | cancel, if any, triggered Timing Advance Reporting procedure; | |
| 1> | cancel, if any, triggered Recommended bit rate query procedure; | |
| 1> | cancel, if any, triggered Configured uplink grant confirmation; | |
| 1> | cancel, if any, triggered configured sidelink grant confirmation; | |
| 1> | cancel, if any, triggered Desired Guard Symbol query; | |
| 1> | cancel, if any, triggered Positioning Measurement Gap Activation/Deactivation | |
| | Request procedure; | |
| 1> | cancel, if any, triggered SDT procedure; | |
| 1> | flush the soft buffers for all DL HARQ processes, except for the DL HARQ process | |
| | being used for MBS broadcast; | |
| 1> | for each DL HARQ process, except for the DL HARQ process being used for MBS | |
| | broadcast, consider the next received transmission for a TB as the very first | |
| | transmission; | |
| 1> | release, if any, Temporary C-RNTI; | |
| 1> | if upper layers indicate SCG deactivation and bfd-and-RLM with value true is not | |
| | configured; or | |
| 1> | if the MAC reset is not due to SCG deactivation: | |
| | 2> | reset all BFI_COUNTERs; |

| | |
|---|---|
| 1> | reset all LBT_COUNTERs. |

If a Sidelink specific reset of the MAC entity is requested for a PC5-RRC connection by
upper layers, the MAC entity shall:

| | |
|---|---|
| 1> | flush the soft buffers for all Sidelink processes for all TB(s) associated to the PC5- |
| | RRC connection; |
| 1> | consider all Sidelink processes for all TB(s) associated to the PC5-RRC connection |
| | as unoccupied; |
| 1> | cancel, if any, triggered Scheduling Request procedure only associated to the PC5- |
| | RRC connection; |
| 1> | cancel, if any, triggered Sidelink Buffer Status Reporting procedure only associated |
| | to the PC5-RRC connection; |
| 1> | cancel, if any, triggered Sidelink CSI Reporting procedure associated to the PC5- |
| | RRC connection; |
| 1> | cancel, if any, triggered Sidelink DRX Command MAC CE associated to the PC5- |
| | RRC connection; |
| 1> | cancel, if any, triggered Sidelink IUC-Request transmission procedure associated to |
| | the PC5-RRC connection; |
| 1> | cancel, if any, triggered Sidelink IUC-Information Reporting procedure associated |
| | to the PC5-RRC connection; |
| 1> | stop (if running) all timers associated to the PC5-RRC connection; |
| 1> | reset the numConsecutiveDTX associated to the PC5-RRC connection; |
| 1> | initialize SBj for each logical channel associated to the PC5-RRC connection to zero. |

| | |
|---|---|
| 5.29 | Activation/Deactivation of SCG |

The network may activate and deactivate the configured SCG.
The MAC entity shall for the configured SCG:

| 1> | if upper layers indicate that SCG is activated: | |
|---|---|---|
| | 2> | if BFI_COUNTER >= beamFailureInstanceMaxCount for the PSCell or the |
| | | timeAlignmentTimer associated with PTAG is not running: |

| | |
|---|---|
| 3> | indicate to upper layers that a Random Access Procedure (as specified in clause |
| | 5.1.1) is needed for SCG activation. |

| | |
|---|---|
| 2> | activate the SCG according to the timing defined in TS 38.133 [11]. |
| 2> | (re-)initialize any suspended configured uplink grants of configured grant Type 1 |
| | associated with this PSCell according to the stored configuration, if any, and to |
| | start in the symbol according to rules in clause 5.8.2.2; |
| 2> | apply normal SCG operation including: |

| | |
|---|---|
| 3> | SRS transmissions on the PSCell; |
| 3> | CSI reporting for the PSCell; |
| 3> | PDCCH monitoring on the PSCell; |
| 3> | PUCCH transmissions on the PSCell; |
| 3> | transmit on RACH on the PSCell; |
| 3> | initialize Bj for each logical channel to zero. |

| 1> | else if upper layers indicate that the SCG is deactivated: | |
|---|---|---|
| | 2> | deactivate all the SCells of the SCG according to clause 5.9; |
| | 2> | deactivate SCG according to the timing defined in TS 38.133 [11]; |
| | 2> | clear any configured downlink assignment and any configured uplink grant Type |
| | | 2 associated with the PSCell respectively; |
| | 2> | suspend any configured uplink grant Type 1 associated with the PSCell; |
| | 2> | reset MAC according to clause 5.12. |
| 1> | if the SCG is deactivated: | |
| | 2> | not transmit SRS on the PSCell; |
| | 2> | not report CSI for the PSCell; |
| | 2> | not transmit on UL-SCH on the PSCell; |
| | 2> | not transmit PUCCH on the PSCell; |
| | 2> | not transmit on RACH on the PSCell; |
| | 2> | not monitor the PDCCH on the PSCell. |

Therefore, the SCG deactivation may not affect the HARQ buffers associated with the PSCell. In this case, even if the network has granted the new data transmission, the uplink transmission of the terminal device may not be considered as the new data transmission (for example, without successfully obtaining a new data indicator, NDI) since the HARQ buffers are not empty. The details regarding the HARQ process are defined below:

| | |
|---|---|
| 5.4.2 | HARQ operation |
| 5.4.2.1 | HARQ Entity |

For each uplink grant, the HARQ entity shall:

| 1> | identify the HARQ process associated with this grant, and for each identified HARQ | |
|---|---|---|
| | process: | |
| | 2> | if the received grant was not addressed to a Temporary C-RNTI on PDCCH, and |
| | | the NDI provided in the associated HARQ information has been toggled |
| | | compared to the value in the previous transmission of this TB of this HARQ |
| | | process; or |
| | 2> | if the uplink grant was received on PDCCH for the C-RNTI and the HARQ buffer |
| | | of the identified process is empty; or |
| | 2> | if the uplink grant was received in a Random Access Response (i.e. in a MAC |
| | | RAR or a fallback RAR); or |
| | 2> | if the uplink grant was determined as specified in clause 5.1.2a for the |
| | | transmission of the MSGA payload; or |
| | 2> | if the uplink grant was received on PDCCH for the C-RNTI in ra- |
| | | ResponseWindow and this PDCCH successfully completed the Random Access |
| | | procedure initiated for beam failure recovery; or |
| | 2> | if the uplink grant is part of a bundle of the configured uplink grant, and may be |
| | | used for initial transmission according to clause 6.1.2.3 of TS 38.214 [7], and if |
| | | no MAC PDU has been obtained for this bundle: |

| | |
|---|---|
| 3> | if there is a MAC PDU in the MSGA buffer and the uplink grant determined |
| | as specified in clause 5.1.2a for the transmission of the MSGA payload was |
| | selected; or |
| 3> | if there is a MAC PDU in the MSGA buffer and the uplink grant was received |
| | in a fallbackRAR and this fallbackRAR successfully completed the Random |
| | Access procedure: |

| | |
|---|---|
| 4> | obtain the MAC PDU to transmit from the MSGA buffer. |

| | |
|---|---|
| 3> | else if there is a MAC PDU in the Msg3 buffer and the uplink grant was |
| | received in a fallbackRAR: |

| | |
|---|---|
| 4> | obtain the MAC PDU to transmit from the Msg3 buffer. |

| | |
|---|---|
| 3> | else if there is a MAC PDU in the Msg3 buffer and the uplink grant was |
| | received in a MAC RAR; or: |
| 3> | if there is a MAC PDU in the Msg3 buffer and the uplink grant was received |
| | on PDCCH for the C-RNTI in ra-ResponseWindow and this PDCCH |
| | successfully completed the Random Access procedure initiated for beam |
| | failure recovery: |

| | |
|---|---|
| 4> | obtain the MAC PDU to transmit from the Msg3 buffer. |
| 4> | if the uplink grant size does not match with size of the obtained MAC PDU; |
| | and |
| 4> | if the Random Access procedure was successfully completed upon |
| | receiving the uplink grant: |

| | |
|---|---|
| 5> | indicate to the Multiplexing and assembly entity to include MAC |
| | subPDU(s) carrying MAC SDU from the obtained MAC PDU in the |
| | subsequent uplink transmission; |
| 5> | obtain the MAC PDU to transmit from the Multiplexing and assembly |
| | entity. |

| | |
|---|---|
| 3> | else if this uplink grant is a configured grant configured with autonomousTx; |
| | and |
| 3> | if the previous configured uplink grant, in the BWP, for this HARQ process |
| | was not prioritized; and |
| 3> | if a MAC PDU had already been obtained for this HARQ process; and |
| 3> | if the uplink grant size matches with size of the obtained MAC PDU; and |
| 3> | if none of PUSCH transmission(s) of the obtained MAC PDU has been |
| | completely performed: |

| | |
|---|---|
| 4> | consider the MAC PDU has been obtained. |

| | |
|---|---|
| 3> | else if the MAC entity is not configured with lch-basedPrioritization; or |
| 3> | if this uplink grant is a prioritized uplink grant: |

| | |
|---|---|
| 4> | obtain the MAC PDU to transmit from the Multiplexing and assembly |
| | entity, if any; |

| | |
|---|---|
| 3> | if a MAC PDU to transmit has been obtained: |

| | |
|---|---|
| 4> | if the uplink grant is not a configured grant configured with autonomousTx; |
| | or |
| 4> | if the uplink grant is a prioritized uplink grant: |

| | |
|---|---|
| 5> | deliver the MAC PDU and the uplink grant and the HARQ information |
| | of the TB to the identified HARQ process; |
| 5> | instruct the identified HARQ process to trigger a new transmission; |
| 5> | if the uplink grant is a configured uplink grant: |

| | |
|---|---|
| 6> | start or restart the configuredGrantTimer, if configured, for the |
| | corresponding HARQ process when the transmission is performed if |
| | LBT failure indication is not received from lower layers; |
| 6> | start or restart the cg-RetransmissionTimer, if configured, for the |
| | corresponding HARQ process when the transmission is performed if |
| | LBT failure indication is not received from lower layers. |
| 6> | if the configured uplink grant is for the initial transmission for CG- |
| | SDT with CCCH message: |

| | |
|---|---|
| 7> | start or restart the cg-SDT-RetransmissionTimer, if configured, for |
| | the corresponding HARQ process when the transmission is |
| | performed. |

| | |
|---|---|
| 5> | if the uplink grant is addressed to C-RNTI, and the identified HARQ |
| | process is configured for a configured uplink grant: |

| | |
|---|---|
| 6> | start or restart the configuredGrantTimer, if configured, for the |
| | corresponding HARQ process when the transmission is performed if |
| | LBT failure indication is not received from lower layers. |

| | |
|---|---|
| 5> | if cg-RetransmissionTimer is configured for the identified HARQ |
| | process; and |
| 5> | if the transmission is performed and LBT failure indication is received |
| | from lower layers: |

| | |
|---|---|
| 6> | consider the identified HARQ process as pending. |

| | |
|---|---|
| 3> | else: |

| | |
|---|---|
| 4> | flush the HARQ buffer of the identified HARQ process. |

| | |
|---|---|
| 2> | else (i.e. retransmission): |

| | |
|---|---|
| 3> | if the uplink grant received on PDCCH was addressed to CS-RNTI and if the |
| | HARQ buffer of the identified process is empty; or |
| 3> | if the uplink grant is part of a bundle and if no MAC PDU has been obtained |
| | for this bundle; or |
| 3> | if the uplink grant is part of a bundle of the configured uplink grant, and the |
| | PUSCH duration of the uplink grant overlaps with an uplink grant received in |
| | a Random Access Response (i.e. MAC RAR or fallbackRAR) or an uplink |
| | grant determined as specified in clause 5.1.2a for MSGA payload for this |
| | Serving Cell; or: |
| 3> | if the MAC entity is not configured with lch-basedPrioritization and this |
| | uplink grant is part of a bundle of the configured uplink grant, and the PUSCH |
| | duration of the uplink grant overlaps with a PUSCH duration of another uplink |
| | grant received on the PDCCH; or: |
| 3> | if the MAC entity is configured with lch-basedPrioritization and this uplink |
| | grant is not a prioritized uplink grant: |

| | |
|---|---|
| 4> | ignore the uplink grant. |

| | |
|---|---|
| 3> | else: |

| | |
|---|---|
| 4> | deliver the uplink grant and the HARQ information (redundancy version) |
| | of the TB to the identified HARQ process; |
| 4> | instruct the identified HARQ process to trigger a retransmission; |
| 4> | if the uplink grant is addressed to CS-RNTI; or |
| 4> | if the uplink grant is addressed to C-RNTI, and the identified HARQ process |
| | is configured for a configured uplink grant: |

| | |
|---|---|
| 5> | start or restart the configuredGrantTimer, if configured, for the |
| | corresponding HARQ process when the transmission is performed if |
| | LBT failure indication is not received from lower layers. |

| | |
|---|---|
| 4> | if the uplink grant is a configured uplink grant: |

| | |
|---|---|
| 5> | if the identified HARQ process is pending: |

| | |
|---|---|
| 6> | start or restart the configuredGrantTimer, if configured, for the |
| | corresponding HARQ process when the transmission is performed if |
| | LBT failure indication is not received from lower layers; |

| | |
|---|---|
| 5> | start or restart the cg-RetransmissionTimer, if configured, for the |
| | corresponding HARQ process when the transmission is performed if |
| | LBT failure indication is not received from lower layers. |
| 5> | if the configured uplink grant is for the retransmission of the initial |
| | transmission of the CG-SDT with CCCH message: |

| | |
|---|---|
| 6> | start or restart the cg-SDT-RetransmissionTimer for the corresponding |
| | HARQ process when transmission is performed. |

| | |
|---|---|
| 4> | if the identified HARQ process is pending and the transmission is |
| | performed and LBT failure indication is not received from lower layers: |

| | |
|---|---|
| 5> | consider the identified HARQ process as not pending. |

As can be seen above, in the case that a HARQ buffer does not include any data, the grant addressed to cell-radio network temporary identifier (C-RNTI) is necessarily considered to be a new transmission. Otherwise, the terminal device needs to determine whether the transmission is a new transmission or a re-transmission based on the NDI value. Therefore, there may emerge the following situation.

That is, when the SCG is newly activated, the uplink (UL) HARQ buffers associated with the PSCell may not be empty (or rather necessarily they have data). The network would usually attempt to first schedule UE with NDI=1 to ensure UE attempts a new transmission. However, since the NDI of each of the HARQ buffers may be still set to NDI=0 (in some cases, the previous SCG deactivation may set the NDIs for all uplink HARQ processes to the value 0), the network device may not schedule a new transmission from the corresponding UE. For example, the DCI providing the UL grant may be lost (even multiple times), and the corresponding UE therefore not toggles the NDI value. In addition, the network device may determine that the used modulation and coding scheme (MCS) is too optimistic, and the network device may attempt to provide a new UL grant with NDI=0 with much more conservative MCS—also it could reduce the TB (Transport Block) size, hence, also changing the NDI value to be “0”. In this case, the network device may also not schedule a new transmission from the corresponding UE.

On the other hand, if the UE had data in the UL HARQ buffer from the time when the SCG was last time activated and the HARQ buffer was not flushed to be empty, the HARQ buffer may include very old data which should no more be received by the network device. For instance, such old data may include UL medium access control (MAC) control elements (CE) or radio link control (RLC) data or segments of RLC segment data units (SDU) for which there would be no other segment anymore in the UE's RLC buffer (e.g., RLC reset upon SCG deactivation).

In view of the above and in order to improve the performance of a communication system, a scheme for DC communication is provided. In this scheme, an apparatus determines an activation or deactivation of a secondary cell group, SCG, of the apparatus. For example, the apparatus may receive an indication of the activation or deactivation of the SCG from a network device. Alternatively, the upper layer may indicate that the SCG is deactivated or activated. Then, the apparatus flushes one or more HARQ buffers associated with the PSCell of the apparatus based on the determination of the activation or deactivation of the SCG.

In this way, PSCell related HARQ buffers can be also flushed timely. As such, meaningful data transmission can be scheduled accordingly.

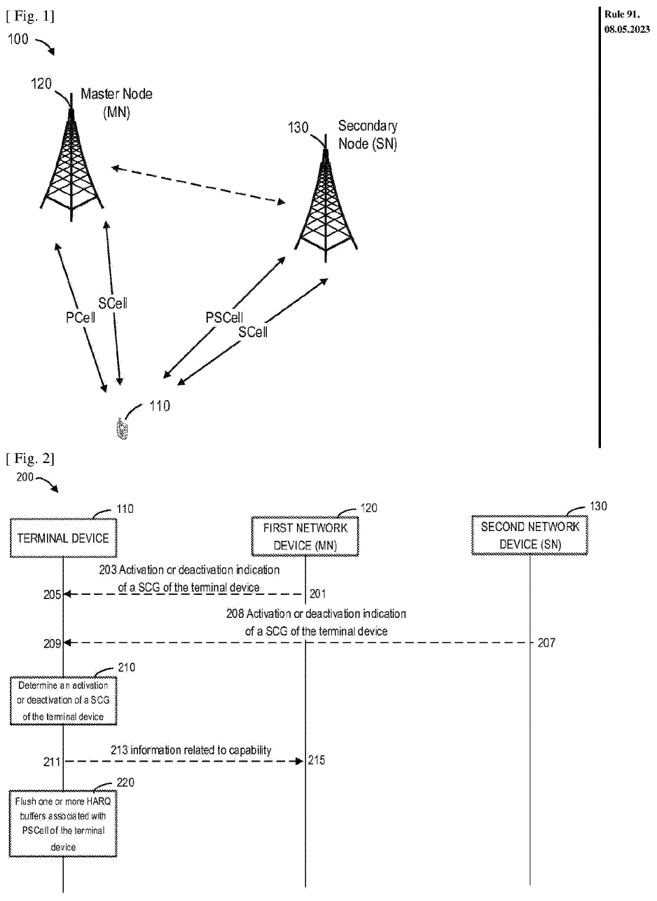

Principle and embodiments of the present disclosure will be described in detail below with reference to the accompanying drawings. FIG. 1 illustrates an example network environment 100 in which example embodiments of the present disclosure may be implemented.

The environment 100, which may be a part of a communication network, includes a terminal device and a network devices communicating with each other or with other devices via each other. In the network environment 100, the terminal device 110 and the network device 120 can communicate data and control information with each other. A link from the network device 120 to the terminal device 110 is referred to as a downlink (DL), while a link from the terminal device 110 to the network device 120 is referred to as an uplink (UL). The network environment 100 may comprise any suitable number of devices and cells. As shown in FIG. 1, in the DC communication, the terminal device 110 may access the network via the first network device 120 and the second network device 130. Without any limitation, the first network device 120 may be the master node (MN) of the terminal device 110 and the second network device 130 may be secondary node (SN) of the terminal device 110. Specifically, MN 120 may provide the MSG comprising the PCell and one or more SCells for the terminal device 110. SN 130 may provide the SCG comprising the PSCell and one or more other SCells for the terminal device 110. The terminal device 110 may utilize the radio resources on multiple component carriers from two cell groups (i.e., the MCG and SCG) for the UL or DL data transmission.

It is to be understood that the number of network devices, terminal devices and other objects is given only for the purpose of illustration without suggesting any limitations. The network environment 100A may include any suitable number of network devices and/or terminal devices adapted for implementing embodiments of the present disclosure. Although not shown, it would be appreciated that one or more terminal devices may be located in the environment 100A.

Communications in the network environment 100 may be implemented according to any proper communication protocol (s), comprising, but not limited to, the third generation (3G), the fourth generation (4G), the fifth generation (5G), 5G-Advanced or beyond (6G), wireless local network communication protocols such as institute for electrical and electronics engineers (IEEE) 802.11 and the like, and/or any other protocols currently known or to be developed in the future. Moreover, the communication may utilize any proper wireless communication technology, comprising but not limited to: multiple-input multiple-output (MIMO), orthogonal frequency division multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), carrier aggregation (CA), dual connectivity (DC), and new radio unlicensed (NR-U) technologies.

FIG. 2 illustrates an example signaling process 200 for the DC communication according to some embodiments of the present disclosure. For the purpose of discussion, the process 200 will be described with reference to FIG. 1. It would be appreciated that although the process 200 has been described in the communication environment 100 of FIG. 1, this process 200 may be likewise applied to other communication scenarios.

In the signaling process 200, a terminal device 110 determines (210) an activation or deactivation of a SCG of the terminal device 110. It is to be understood that although the embodiments in FIG. 2 are discussed with reference to the terminal device 110, it can be also any other apparatus that can access the network device via the first network device 120 and the second network device 130. In some embodiments, the first network device 120 acting as the master node of the terminal device 110 may transmit (201) activation or deactivation indication (203) of the SCG to the terminal device 110. Upon receiving (205) the activation or deactivation indication, the terminal device 110 may determine (210) that the SCG is activated or deactivated. In addition or alternatively, the second network device 130 acting as the secondary network device of the terminal device 110 may transmit (201) activation or deactivation indication (203) of the SCG to the terminal device 110. Upon receiving (209) the activation or deactivation indication, the terminal device 110 may determine (210) that the SCG is activated or deactivated. Without any limitation, the terminal device 110 may also determine the SCG activation or deactivation autonomously and send the activation or deactivation indication to the first network device 120 or the second network device 130.

Then, based at least on determining the activation or deactivation of the SCG, the terminal device 110 flushes (220) one or more HARQ buffers associated with a PSCell of the terminal device 110. In some embodiments, if the upper layers (for example, packet data convergence protocol, PDCP, layer and/or radio link control, RLC, layer) indicate that the SCG is deactivated or activated, the terminal device 110 may flush the one or more HARQ buffers associated with a PSCell of the terminal device 110. In addition or alternatively, the terminal device 110 may directly flush the one or more HARQ buffers associated with the PSCell when the SCG is activated or deactivated (for example, upon the activation or deactivation of the SCG).

In this way, once the SCG is triggered to be activated or deactivated, the terminal device 110 may flush the HARQ buffers associated with the PSCell, for example, to be empty. As such, the terminal device may perform new data transmission in time, or the very old data may not be transmitted.

In addition or alternatively, if determining the SCG is deactivated or activated, the terminal device 110 may further determine whether a timeAlignmentTimer associated with a primary timing advance group, PTAG, for the apparatus is running. If the timeAlignmentTimer is running, the terminal device 110 may flush the one or more HARQ buffers associated with the PSCell. In this way, the terminal device 110 may flush the HARQ buffers more efficiently, since the expiration of the timeAlignmentTime may also cause the flushing the HARQ buffers.

In addition, the terminal device 110 may send information related to capability of flushing HARQ buffers to the network device 120 or 130. In some embodiments, the information related to capability may indicate at least one of: flushing one or more HARQ buffers associated with a PSCell while a timeAlignmentTimer associated with a PTAG is running; or flushing one or more HARQ buffers associated with a PSCell upon SCG activation or deactivation. In this way, the network may be aware of which terminal device can flush the HARQ buffers associated with the PSCell.

Accordingly, the network device 120 or 130 may transmit the grant to the terminal devices which have the above HARQ buffer flushing capability in a more optimistic way, for example, using higher modulation and coding scheme (MCS) order. Otherwise, the network device 120 or 130 could deduce that needs to be extremely cautious in the first transmissions in the PSCell after SCG activation (in case the terminal device did not indicate the capability). For example, the network device 120 may use lower MCS order to transmit PDCCH to ensure the DCI having the grant can be received by the terminal device.

It is to be understood that although above embodiments are discussed with reference to network devices 120 and 130, the embodiments may be also implemented by any other apparatuses that can provide serving cells for the terminal devices.

Alternatively, the above embodiments may be also expressed as below:

| | |
|---|---|
| 5.29 | Activation/Deactivation of SCG |

The network may activate and deactivate the configured SCG.
The MAC entity shall for the configured SCG:

| 1> | if upper layers indicate that SCG is activated: | |
|---|---|---|
| | 2> | if BFI_COUNTER >= beamFailureInstanceMaxCount for the PSCell or the |
| | | timeAlignmentTimer associated with PTAG is not running: |

| | |
|---|---|
| 3> | indicate to upper layers that a Random Access Procedure (as specified in clause |
| | 5.1.1) is needed for SCG activation. |

| | |
|---|---|
| 2> | activate the SCG according to the timing defined in TS 38.133 [11]; |
| 2> | if the timeAlignmentTimer is associated with the PTAG is running: |

| | |
|---|---|
| 3> | flush all HARQ buffers associated with the PSCell; |

| | |
|---|---|
| 2> | flush all HARQ buffers associated with the PSCell; |
| 2> | (re-)initialize any suspended configured uplink grants of configured grant Type 1 |
| | associated with this PSCell according to the stored configuration, if any, and to |
| | start in the symbol according to rules in clause 5.8.2.2; |
| 2> | apply normal SCG operation including: |

| | |
|---|---|
| 3> | SRS transmissions on the PSCell; |
| 3> | CSI reporting for the PSCell; |
| 3> | PDCCH monitoring on the PSCell; |
| 3> | PUCCH transmissions on the PSCell; |
| 3> | transmit on RACH on the PSCell; |
| 3> | initialize Bj for each logical channel to zero. |

| 1> | else if upper layers indicate that the SCG is deactivated: | |
|---|---|---|
| | 2> | deactivate all the SCells of the SCG according to clause 5.9; |
| | 2> | deactivate SCG according to the timing defined in TS 38.133 [11]; |
| | 2> | clear any configured downlink assignment and any configured uplink grant Type |
| | | 2 associated with the PSCell respectively; |
| | 2> | suspend any configured uplink grant Type 1 associated with the PSCell; |
| | 2> | reset MAC according to clause 5.12. |
| | 2> | if the timeAlignmentTimer is associated with the PTAG is running: |

| | |
|---|---|
| 3> | flush all HARQ buffers associated with the PSCell; |

| | 2> | flush all HARQ buffers associated with the PSCell; |
|---|---|---|
| 1> | if the SCG is deactivated: | |
| | 2> | not transmit SRS on the PSCell; |
| | 2> | not report CSI for the PSCell; |
| | 2> | not transmit on UL-SCH on the PSCell; |
| | 2> | not transmit PUCCH on the PSCell; |
| | 2> | not transmit on RACH on the PSCell; |
| | 2> | not monitor the PDCCH on the PSCell. |

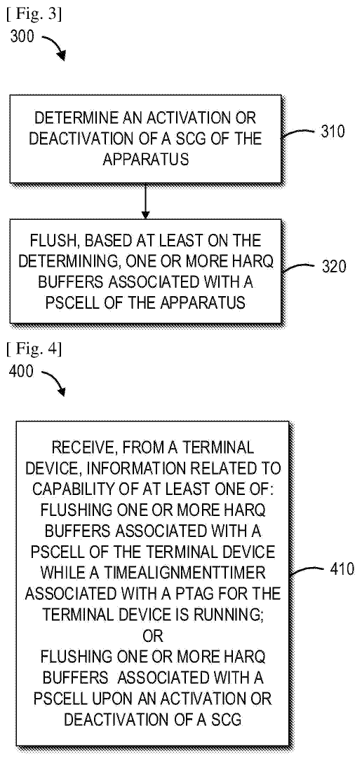

FIG. 3 shows a flowchart of an example method 300 implemented at a terminal device (for example, the terminal device 110) in accordance with some embodiments of the present disclosure. For the purpose of discussion, the method 300 will be described from the perspective of the terminal device 110 with reference to FIG. 1. However, it is understood that the example method 300 can be more generally performed by an apparatus which can be involved in activation or deactivation of a SCG.

At 310, the terminal device 110 determines an activation or deactivation of a SCG of terminal device 110. At 320, the terminal device 310 flushes, based at least on the determining the activation or deactivation of the SCG, one or more HARQ buffers associated with a PSCell of the terminal device 110.

In some embodiments, the terminal device 110 may determine that a timeAlignmentTimer associated with a primary timing advance group, PTAG, for the apparatus is running. Then, based at least on both the determining the activation or deactivation of the SCG and the determining that the timeAlignmentTimer associated with the PTAG is running, the terminal device 110 may flush the one or more HARQ buffers associated with the PSCell.

In some embodiments, the terminal device 110 may flush the one or more HARQ buffers associated with the PSCell, upon the activation or deactivation of the SCG.

In some embodiments, the terminal device 110 may transmit, to a network device, information related to capability of at least one of: flushing one or more HARQ buffers associated with a PSCell while a timeAlignmentTimer associated with a PTAG is running; or flushing one or more HARQ buffers associated with a PSCell upon an activation or deactivation of a SCG. In some embodiments, the PSCell is comprised in the SCG.

FIG. 4 shows a flowchart of an example method 400 implemented at a network device (for example, the first network device 120 or the second network device 130) in accordance with some embodiments of the present disclosure. For the purpose of discussion, the method 400 will be described from the perspective of the network device 110 with reference to FIG. 1. However, it is understood that the example method 400 can be more generally performed by an apparatus which can be involved in activation or deactivation of a SCG.

At 410, the network device 110 receives, from a terminal device, information related to capability of at least one of: flushing one or more HARQ buffers associated with a PSCell of the terminal device while a timeAlignmentTimer associated with PTAG for the terminal device is running; or flushing one or more HARQ buffers associated with a PSCell upon an activation or deactivation of a SCG.

In some embodiments, an apparatus capable of performing any of operations of the method 300 (for example, the terminal device 110) may include at least one processor and at least one memory storing instructions that, when executed by the at least one processor, cause the apparatus at least to determine an activation or deactivation of a SCG of the apparatus. The apparatus is further caused to flush, based at least on the determining the activation or the deactivation of the SCG, one or more HARQ buffers associated with a PSCell of the apparatus.

In some embodiments, the apparatus is further caused to determine that a timeAlignmentTimer associated with a primary timing advance group, PTAG, for the apparatus is running. Then, based at least on both the determining the activation or deactivation of the SCG and the determining that the timeAlignmentTimer associated with the PTAG is running, the terminal device 110 may flush the one or more HARQ buffers associated with the PSCell.

In some embodiments, the apparatus is further caused to flush the one or more HARQ buffers associated with the PSCell, upon the activation or deactivation of the SCG.

In some embodiments, the apparatus is further caused to transmit, to a network device, information related to capability of at least one of: flushing one or more HARQ buffers associated with a PSCell while a timeAlignmentTimer associated with a PTAG is running; or flushing one or more HARQ buffers associated with a PSCell upon an activation or deactivation of a SCG. In some embodiments, the PSCell is comprised in the SCG.

In some embodiments, an apparatus capable of performing any of operations of the method 300 (for example, the terminal device 110) may include means for determining an activation or deactivation of a secondary cell group, SCG, of the apparatus; and means for flushing, based at least on the determining the activation or deactivation of the SCG, one or more hybrid automatic repeat request, HARQ, buffers associated with a primary secondary cell, PSCell of the apparatus.

In some embodiments, the apparatus further comprises: means for determining that a timeAlignmentTimer associated with a primary timing advance group, PTAG, for the apparatus is running; and means for flushing, based at least on both the determining the activation or deactivation of the SCG and the determining that the timeAlignmentTimer associated with the PTAG is running, the one or more HARQ buffers associated with the PSCell.

In some embodiments, the apparatus further comprises: means for flushing the one or more HARQ buffers associated with the PSCell, upon the activation or deactivation of the SCG.

In some embodiments, the apparatus further comprises: means for transmitting, to a network device, information related to capability of at least one of: flushing one or more HARQ buffers associated with a PSCell while a timeAlignmentTimer associated with a PTAG is running; or flushing one or more HARQ buffers associated with a PSCell upon an activation or deactivation of a SCG. In some embodiments, the PSCell is comprised in the SCG.

In some embodiments, the apparatus further comprises means for performing other steps in some embodiments of the method 300. In some embodiments, the means comprises at least one processor and at least one memory including computer program code, the at least one memory and computer program code configured to, with the at least one processor, cause the performance of the apparatus.

In some embodiments, an apparatus capable of performing any of operations of the method 400 (for example, the network device 120 or the network device 130) may include at least one processor and at least one memory storing instructions that, when executed by the at least one processor, cause the apparatus at least to receive, from a terminal device, information related to capability of at least one of: flushing one or more HARQ buffers associated with a PSCell of the terminal device while a timeAlignmentTimer associated with a PTAG for the terminal device is running; or flushing one or more HARQ buffers associated with a PSCell upon an activation or deactivation of a SCG.

In some embodiments, an apparatus capable of performing any of the method 400 (for example, the network device 120 or 130) may include means for receiving, from a terminal device, information related to capability of at least one of: flushing one or more HARQ buffers associated with a PSCell of the terminal device while a timeAlignmentTimer associated with a PTAG for the terminal device is running; or flushing one or more HARQ buffers associated with a PSCell upon an activation or deactivation of a SCG.

In some embodiments, the apparatus further comprises means for performing other steps in some embodiments of the method 400. In some embodiments, the means comprises at least one processor and at least one memory including computer program code, the at least one memory and computer program code configured to, with the at least one processor, cause the performance of the apparatus.

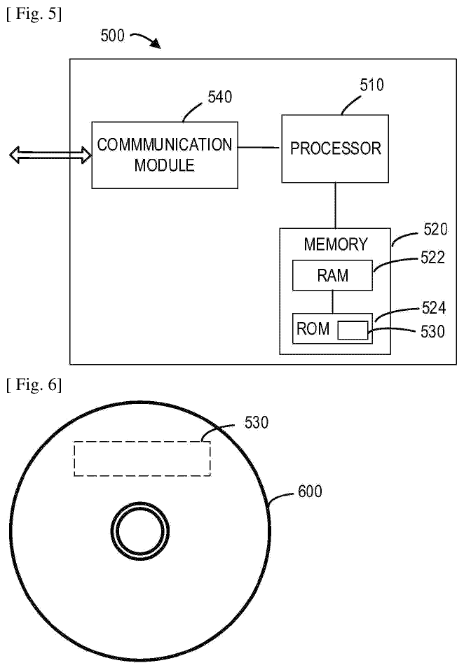

FIG. 5 is a simplified block diagram of a device 500 that is suitable for implementing embodiments of the present disclosure. The device 500 may be provided to implement the communication device, for example the terminal device 110 or the network device 120 or the network device 130 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has at least one antenna to facilitate communication. The communication interface may represent any interface that is necessary for communication with other network elements. The communication interface may be hardware or software based interface. For example, the communication interface may be one or more transceivers. The one or more transceivers may be coupled to one or more antennas or antenna ports to wirelessly transmit and/or receive communication signals. The antennas or antenna ports may be the same or different types. The antennas or antenna ports may be located in different positions of an apparatus. The one or more transceivers allow the apparatus to communicate with other devices that may be wired and/or wireless. The transceiver may support one or more radio technologies. For example, the one or more transceivers may include a cellular subsystem, a WLAN subsystem, and/or a Bluetooth™ subsystem. The one or more transceivers may include processors, controllers, radios, sockets, plugs, buffers, or the like circuits to form one or more communication channels to one or more radio frequency units.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a read only memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1222 and other volatile memories that will not last in the power-down duration.

A program 530 includes executable instructions that are executed by the associated processor 510. The program 530 may be stored in the ROM 524. The processor 510 may perform any suitable actions and processing by loading the program 530 into the RAM 522.

The embodiments of the present disclosure may be implemented by means of the program so that the device 500 may perform any process of the disclosure as discussed with reference to FIGS. 2 to 4. The embodiments of the present disclosure may also be implemented by hardware or by a combination of software and hardware.

FIG. 6 illustrates an example block diagram of an example computer readable medium in accordance with some embodiments of the present disclosure

In some embodiments, the program 530 may be tangibly contained in a readable storage medium which may be included in the device 500 (such as in the memory 520) or other storage devices that are accessible by the device 500. The device 500 may load the program 530 from the storage medium to the RAM 522 for execution. The storage medium may include any types of tangible non-volatile storage, such as ROM, EPROM, a flash memory, a hard disk, CD, DVD, and the like. FIG. 6 shows an example of the storage medium 600 in form of CD or DVD. The storage medium has the processor instructions 630 stored therein.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one program product tangibly stored on a non-transitory readable storage medium. The program product includes executable instructions, such as those included in program modules, being executed in a device on a target real or virtual processor, to carry out process 200, the method 400 or 500 as described above with reference to FIG. 2 to FIG. 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the program codes or related data may be carried by any suitable carrier to enable the device, apparatus or processor to perform various processes and operations as described above. Examples of the carrier include a signal, readable storage medium, and the like.

The readable medium may be a readable signal medium or a readable storage medium. A readable storage medium may include but not limited to an electronic, magnetic, optical, electromagnetic, infrared, or semiconductor system, apparatus, or device, or any suitable combination of the foregoing. More specific examples of the readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. An apparatus comprising:
at least one processor; and
at least one memory storing instructions that, when executed by the at least one processor, cause the apparatus at least to:
determine an activation or deactivation of a secondary cell group, SCG, of the apparatus; and
flush, based at least on the determining the activation or deactivation of the SCG, one or more hybrid automatic repeat request, HARQ, buffers associated with a primary secondary cell, PSCell, of the apparatus.

22. The apparatus of claim 21, wherein the apparatus is further caused to:
determine that a timeAlignmentTimer associated with a primary timing advance group, PTAG, for the apparatus is running; and
flush, based at least on both the determining the activation or deactivation of the SCG and the determining that the timeAlignmentTimer associated with the PTAG is running, the one or more HARQ buffers associated with the PSCell.

23. The apparatus of claim 21, wherein the apparatus is further caused to:
flush the one or more HARQ buffers associated with the PSCell, upon the activation or deactivation of the SCG.

24. The apparatus of claim 21, wherein the apparatus is further caused to:
transmit, to a network device, information related to capability of at least one of:
flushing one or more HARQ buffers associated with a PSCell while a timeAlignmentTimer associated with a PTAG is running; or
flushing one or more HARQ buffers associated with a PSCell upon an activation or deactivation of a SCG.

25. The apparatus of claim 21, wherein the PSCell is comprised in the SCG.

26. An apparatus comprising:
at least one processor; and
at least one memory storing instructions that, when executed by the at least one processor, cause the apparatus at least to:
receive, from a terminal device, information related to capability of at least one of:
flushing one or more hybrid automatic repeat request, HARQ, buffers associated with a primary secondary cell, PSCell, of the terminal device while a timeAlignmentTimer associated with a primary timing advance group, PTAG, for the terminal device is running; or
flushing one or more HARQ buffers associated with a PSCell upon an activation or deactivation of a secondary cell group, SCG.

27. The apparatus of claim 26, wherein the apparatus is further caused to:
transmit grant to the terminal device using higher modulation and coding scheme, MCS, order.

28. The apparatus of claim 26, wherein the apparatus is further caused to:
transmit physical downlink control channel to the terminal device using lower modulation and coding scheme, MCS, order.

29. A method comprising:
determining, by a terminal device, an activation or deactivation of a secondary cell group, SCG, of the terminal device; and
flushing, by the terminal device and based at least on the determining the activation or deactivation of the SCG, one or more hybrid automatic repeat request, HARQ, buffers associated with a primary secondary cell, PSCell, of the terminal device.

30. The method of claim 29, further comprising:
determining, by the terminal device, that a timeAlignmentTimer associated with a primary timing advance group, PTAG, for the terminal device is running; and
flushing, by the terminal device and based at least on both the determining the activation or deactivation of the SCG and the determining that the timeAlignmentTimer associated with the PTAG is running, the one or more HARQ buffers associated with the PSCell.

31. The method of claim 29, further comprising:
flushing, by the terminal device, the one or more HARQ buffers associated with the PSCell, upon the activation or deactivation of the SCG.

32. The method of claim 29, further comprising:
transmitting, by the terminal device and to a network device, information related to capability of at least one of:
flushing one or more HARQ buffers associated with a PSCell while a timeAlignmentTimer associated with a PTAG is running; or
flushing one or more HARQ buffers associated with a PSCell upon an activation or deactivation of a SCG.

33. The method of claim 29, wherein the PSCell is comprised in the SCG.
